(19) United States
(12) Patent Application Publication
(10) Pub. No.: US 2020/0156991 A1
(43) Pub. Date: May 21, 2020

(54) GLASS ARTICLES HAVING DAMAGE-RESISTANT COATINGS AND METHODS FOR COATING GLASS ARTICLES

(71) Applicant: CORNING INCORPORATED, Corning, NY (US)

(72) Inventors: Eric Lewis Allington, Campbell, NY (US); Matthew Lee Black, Naples, NY (US); Steven Edward DeMartino, Painted Post, NY (US); Jody Paul Markley, Watkins Glen, NY (US); Charles Andrew Paulson, Painted Post, NY (US); Jamie Todd Westbrook, Sayre, PA (US)

(21) Appl. No.: 16/658,240

(22) Filed: Oct. 21, 2019

Related U.S. Application Data
(60) Provisional application No. 62/769,758, filed on Nov. 20, 2018.

(51) Int. Cl. C03C 17/00; C03C 17/22; C03C 17/245; C03C 21/00; B65D 23/08

(52) U.S. Cl. CPC C03C 17/005; C03C 17/225; C03C 17/245; C03C 2218/152; B65D 23/0814; C03C 2217/78; C03C 21/002

(57) ABSTRACT

A coated glass article and methods for producing the same are provided herein. The coated glass article includes a glass body having a first surface and a second surface opposite the first surface, wherein the first surface is an exterior surface of the glass body, and a damage-resistant coating formed by atomic layer deposition, the damage-resistant coating being disposed on at least a portion of the first surface of the glass body.

### CROSS-REFERENCE TO RELATED APPLICATION

This application claims the benefit of priority under 35 U.S.C § 120 of U.S. Provisional Application Ser. No. 62/769,758 filed on Nov. 20, 2018, the content of which is relied upon and incorporated herein by reference in its entirety.

### FIELD

The present disclosure generally relates to glass articles having damage-resistant coatings and, more particularly, to damage-resistant coatings applied by Atomic Layer Deposition (ALD) to glass articles such as pharmaceutical packages.

### BACKGROUND

Historically, glass has been used as a preferred material for many applications, including food and beverage packaging, pharmaceutical packaging, kitchen and laboratory glassware, and windows or other architectural features, because of its hermeticity, optical clarity and excellent chemical durability relative to other materials.

However, use of glass for many applications is limited by the mechanical performance of the glass. In particular, glass breakage is a concern, particularly in the packaging of food, beverages, and pharmaceuticals. Breakage can be costly in the food, beverage, and pharmaceutical packaging industries because, for example, breakage within a filling line may require that neighboring unbroken containers be discarded as the containers may contain fragments from the broken container. Breakage may also require that the filling line be slowed or stopped, lowering production yields. Further, non-catastrophic breakage (i.e., when the glass cracks but does not break) may cause the contents of the glass package or container to lose their sterility which, in turn, may result in costly product recalls.

One root cause of glass breakage is the introduction of flaws in the surface of the glass as the glass is processed and/or during subsequent filling. This is particularly relevant following exposure to elevated temperatures and other conditions, such as those experienced during packaging and pre-packaging steps utilized in packaging pharmaceuticals, such as, for example, depyrogentation, autoclaving and the like. Exposure to such elevated temperatures results in a circumstance of when the glass is more susceptible to flaws caused by mechanical insults such as abrasions, impacts and the like. These flaws may be introduced in the surface of the glass from a variety of sources including contact between adjacent pieces of glassware and contact between the glass and equipment, such as handling and/or filling equipment. Regardless of the source, the presence of these flaws may ultimately lead to glass breakage.

Ion exchange processing is a process used to strengthen glass articles. Ion exchange imparts a compression (i.e., compressive stress) onto the surface of a glass article by chemically replacing smaller ions within the glass article with larger ions from a molten salt bath. The compression on the surface of the glass article raises the mechanical stress threshold to propagate cracks; thereby, improving the overall strength of the glass article. Also, addition of coatings to surfaces of the glass articles may increase damage resistance and impart improved strength and durability to the glass articles. However, some of the same conditions which can render the glass articles more susceptible to damage or flaws may also degrade certain coating materials and reduce, or even eliminate, the ability of such coating materials to protect the glass article from mechanical insults such as abrasions, impacts and the like.

### SUMMARY

According to embodiments of the present disclosure, a coated glass article is provided. The coated glass article includes a glass body having a first surface and a second surface opposite the first surface, wherein the first surface is an exterior surface of the glass body. The coated glass article further includes a damage-resistant coating formed by atomic layer deposition, the damage-resistant coating being disposed on at least a portion of the first surface of the glass body.

According to embodiments of the present disclosure, a method for forming a coated glass container having a damage-resistant coating is provided. The method includes applying a damage-resistant coating to a glass container by atomic layer deposition, wherein applying the damage-resistant coating includes exposing the glass container to a metal precursor and at least one of a water precursor and an amine precursor.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The disclosure will be understood more clearly from the following description and from the accompanying figures, given purely by way of non-limiting example, in which:

FIG. 1 schematically depicts a cross section of a glass container with a low-friction coating according embodiments of the present disclosure; and

FIG. 2 is a flow diagram of a method for forming a glass container with a low-friction coating according embodiments of the present disclosure;

FIG. 3 schematically depicts the steps of the flow diagram of FIG. 2 according embodiments of the present disclosure;

FIG. 4 is a schematic depiction of a vial scratch test according embodiments of the present disclosure; and

FIG. 5 graphically depicts the average measured coefficient of friction for uncoated and containers according embodiments of the present disclosure.

### DETAILED DESCRIPTION

Reference will now be made in detail to the present embodiment(s), an example(s) of which is/are illustrated in the accompanying drawings. Whenever possible, the same reference numerals will be used throughout the drawings to refer to the same or like parts.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

As used herein, “have,” “having,” “include,” “including,” “comprise,” “comprising” or the like are used in their open ended sense, and generally mean “including, but not limited to.”

All scientific and technical terms used herein have meanings commonly used in the art unless otherwise specified. The definitions provided herein are to facilitate understanding of certain terms used frequently herein and are not meant to limit the scope of the present disclosure.

The present disclosure is described below, at first generally, then in detail on the basis of several exemplary embodiments. The features shown in combination with one another in the individual exemplary embodiments do not all have to be realized. In particular, individual features may also be omitted or combined in some other way with other features shown of the same exemplary embodiment or else of other exemplary embodiments.

Embodiments of the present disclosure relate to damage-resistant coatings, glass articles with damage-resistant coatings, and methods for producing the same, examples of which are schematically depicted in the figures. Such coated glass articles may be glass containers suitable for use in various packaging applications including, without limitation, pharmaceutical packages. These pharmaceutical packages may or may not contain a pharmaceutical composition. While embodiments of the damage-resistant coatings described herein are applied to the outer surface of a glass container, it should be understood that the damage-resistant coatings described herein may be used as a coating on a wide variety of materials, including non-glass materials and on substrates other than containers including, without limitation, glass display panels and the like.

Generally, a damage-resistant coating as described herein may be applied to a surface of a glass article, such as a container that may be used as a pharmaceutical package. The damage-resistant coating may provide advantageous properties to the coated glass article such as a reduced coefficient of friction and increased damage resistance. The reduced coefficient of friction may impart improved strength and durability to the glass article by mitigating frictive damage to the glass. Further, the damage-resistant coating may maintain the aforementioned improved strength and durability characteristics following exposure to elevated temperatures and other conditions, such as those experienced during packaging and pre-packaging steps utilized in packaging pharmaceuticals, such as, for example, depyrogentation, autoclaving and the like.

Damage-resistant coatings as described herein are applied to a surface of a glass article by Atomic Layer Deposition (ALD). ALD, including both thermal and plasma assisted processes, allows for deposition of dense thin film and dense ultra-thin film coatings. ALD is a self-limiting layer-by-layer thin film deposition technique composed of successive steps of adsorption and hydrolysis/activation of metal halide or metal alkoxide precursors. This step-by-step deposition process allows complete removal of reactants and by-products before the deposition of the next layer, minimizing the risk of trapping unwanted molecules. Advantageously, layer thicknesses can be precisely controlled with ALD deposition. Additionally, ALD deposition may be utilized to provide conformal coatings to glass articles having curved or otherwise complex 3D geometries. Furthermore, ALD deposition forms pinhole-free films, and facilitates highly repeatable and scalable coating processes. Without wishing to be bound by any particular theory, it is believed that, as compared to conventional coating techniques, the ALD deposited coating may penetrate small and sharp surface scratches and provide further damage resistance to the glass article.

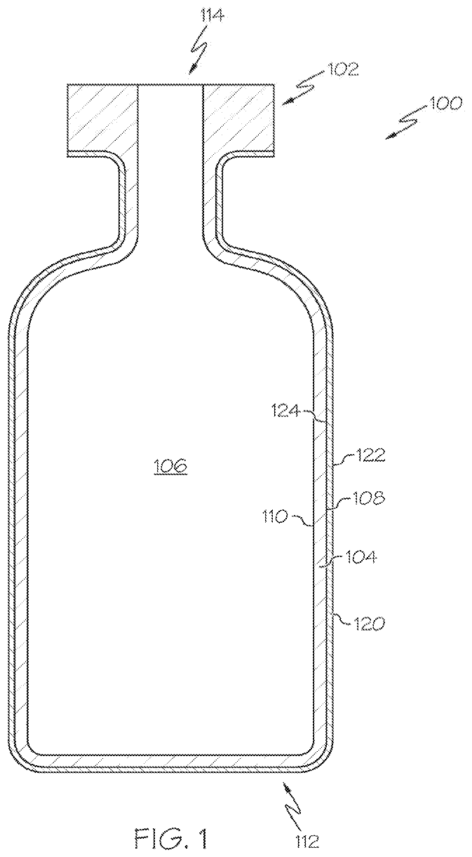

FIG. 1 schematically depicts a cross section of a coated glass article, specifically a coated glass container 100. The coated glass container 100 includes a glass body 102 and a damage-resistant coating 120. The glass body 102 has a glass container wall 104 extending between an exterior surface 108 (i.e., a first surface) and an interior surface 110 (i.e., a second surface). The interior surface 110 of the glass container wall 104 defines an interior volume 106 of the coated glass container 100. A damage-resistant coating 120 is positioned on at least a portion of the exterior surface 108 of the glass body 102. The damage-resistant coating 120 may be positioned on substantially the entire exterior surface 108 of the glass body 102. The damage-resistant coating 120 has an outer surface 122 and a glass body contacting surface 124 at the interface of the glass body 102 and the damage-resistant coating 120. The damage-resistant coating 120 may be bonded to the glass body 102 at the exterior surface 108.

According to embodiments of the present disclosure, the coated glass container 100 may be a pharmaceutical package. For example, the glass body 102 may be in the shape of a vial, ampoule, ampul, bottle, cartridge, flask, phial, beaker, bucket, carafe, vat, syringe body, or the like. The coated glass container 100 may be used for containing any composition, for example a pharmaceutical composition. A pharmaceutical composition may include any chemical substance intended for use in the medical diagnosis, cure, treatment, or prevention of disease. Examples of pharmaceutical compositions include, but are not limited to, medicines, drugs, medications, medicaments, remedies, and the like. The pharmaceutical composition may be in the form of a liquid, solid, gel, suspension, powder, or the like.

According to embodiments of the present disclosure, the damage-resistant coating 120 may be an oxide material or a nitride material. Non-limiting examples of suitable oxides may be those selected from the group of oxides of aluminum, zirconium, zinc, silicon and titanium. Non-limiting examples of suitable nitrides may be those selected from the group of nitrides of aluminum, boron and silicon. The damage-resistant coating 120 may have a thickness of less than or equal to about 1 μm. For example, the thickness of the low damage-resistant coating 120 may be less than or equal to about 250 nm, or less than about 150 nm, or less than about 100 nm, or less than about 90 nm thick, or less than about 80 nm thick, or less than about 70 nm thick, or less than about 60 nm thick, or less than about 50 nm, or even less than about 25 nm thick. The damage-resistant coating 120 may have a non-uniform thickness. For example, the coating thickness may be varied over different regions of a coated glass container 100, which may promote protection in a selected region of the glass body 102.

The glass containers to which the damage-resistant coating 120 may be applied may be formed from a variety of different glass compositions. The specific composition of the glass article may be selected according to the specific application such that the glass has a desired set of physical properties.

The glass containers may be formed from a glass composition which has a coefficient of thermal expansion in the range from about 25×10⁻⁷/° C. to 80×10⁻⁷/° C. For example, the glass body 102 may be formed from alkali aluminosilicate glass compositions which are amenable to strengthening by ion exchange. Such compositions generally include a combination of SiO₂, Al₂O₃, at least one alkaline earth oxide, and one or more alkali oxides, such as Na₂O and/or K₂O. The glass composition may be free from boron and compounds containing boron. Additionally, the glass compositions may further include minor amounts of one or more additional oxides such as, for example, SnO₂, ZrO₂, ZnO, TiO₂, As₂O₃, or the like. These components may be added as fining agents and/or to further enhance the chemical durability of the glass composition. Additionally, the glass surface may include a metal oxide coating comprising SnO₂, ZrO₂, ZnO, TiO₂, As₂O₃, or the like.

According to embodiments of the present disclosure, the glass body 102 may be strengthened such as by ion-exchange strengthening, herein referred to as “ion-exchanged glass”. For example, the glass body 102 may have a compressive stress of greater than or equal to about 300 MPa or even greater than or equal to about 350 MPa, or a compressive stress in a range from about 300 MPa to about 900 MPa. However, it should be understood that the compressive stress in the glass may be less than 300 MPa or greater than 900 MPa. The glass body 102 as described herein may have a depth of layer of greater than or equal to about 20 μm. As used herein, “depth of layer” is defined as a depth to a tensile stress region from a surface of the glass body 102, or as a thickness of a compressive stress region in the glass body 102 as measured from a surface of the glass body 102. For example, the depth of layer may be greater than about 50 μm, or greater than or equal to about 75 μm, or even greater than about 100 μm. The ion-exchange strengthening may be performed in a molten salt bath maintained at temperatures from about 350° C. to about 500° C. To achieve the desired compressive stress, the glass container coated with the coupling agent layer may be immersed in the salt bath for less than about 30 hours or even less than about 20 hours. For example, the glass container may be immersed in a 100% KNO₃ salt bath at 450° C. for about 8 hours.

As one non-limiting example, the glass body 102 may be formed from an ion exchangeable glass composition described in pending U.S. Pat. No. 8,753,994 entitled “Glass Compositions with Improved Chemical and Mechanical Durability” and assigned to Corning, Incorporated, the contents of which are incorporated herein by reference in its entirety.

However, it should be understood that the coated glass containers 100 described herein may be formed from other glass compositions including, without limitation, ion-exchangeable glass compositions and non-ion exchangeable glass compositions. For example, the glass container may be formed from Type 1B glass compositions such as, for example, Schott Type 1B aluminosilicate glass.

According to embodiments of the present disclosure, the glass article may be formed from a glass composition which meets the criteria for pharmaceutical glasses described by regulatory agencies such as the USP (United States Pharmacopoeia), the EP (European Pharmacopeia), and the JP (Japanese Pharmacopeia) based on their hydrolytic resistance. Per USP 660 and EP 7, borosilicate glasses meet the Type I criteria and are routinely used for parenteral packaging. Examples of borosilicate glass include, but are not limited to Corning® Pyrex® 7740, 7800 and Wheaton 180, 200, and 400, Schott Duran, Schott Fiolax, KIMAX® N-51A, Gerrescheimer GX-51 Flint and others. Soda-lime glass meets the Type III criteria and is acceptable in packaging of dry powders which are subsequently dissolved to make solutions or buffers. Type III glasses are also suitable for packaging liquid formulations that prove to be insensitive to alkali. Examples of Type III soda lime glass include Wheaton 800 and 900. De-alkalized soda-lime glasses have higher levels of sodium hydroxide and calcium oxide and meet the Type II criteria. These glasses are less resistant to leaching than Type I glasses but more resistant than Type III glasses. Type II glasses can be used for products that remain below a pH of 7 for their shelf life. Examples include ammonium sulfate treated soda lime glasses. These pharmaceutical glasses have varied chemical compositions and have a coefficient of linear thermal expansion (CTE) in the range of 20-85×10⁻⁷° C.⁻¹.

When the coated glass articles described herein are glass containers, the glass body 102 of the coated glass containers 100 may take on a variety of different forms. For example, the glass bodies described herein may be used to form coated glass containers 100 such as vials, ampoules, cartridges, syringe bodies and/or any other glass container for storing pharmaceutical compositions. Accordingly, it should be understood that the glass containers may be ion exchange strengthened prior to application of the damage-resistant coating 120. Alternatively, other strengthening methods such as heat tempering, flame polishing, and laminating, as described in U.S. Pat. No. 7,201,965 (the contents of which are incorporated herein by reference in its entirety), could be used to strengthen the glass before coating.

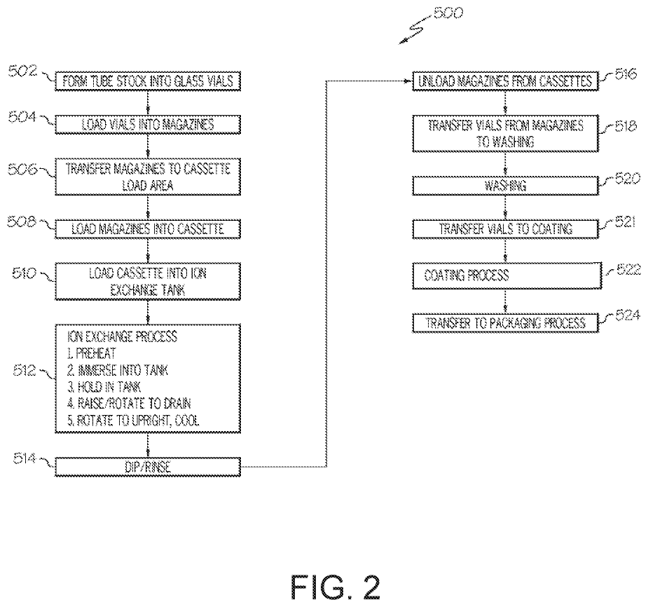

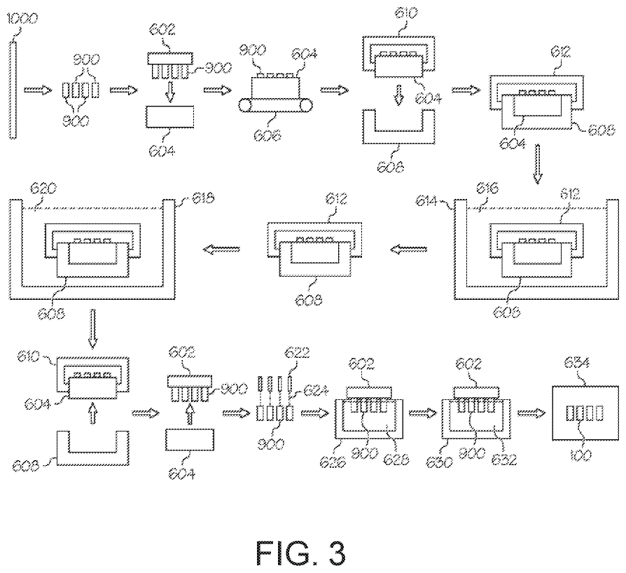

Provided herein is a method for increasing the durability of glass article by coating with a damage-resistant coating. Referring collectively to FIGS. 2 and 3, FIG. 2 contains a process flow diagram 500 of a method for producing a coated glass container 100 having a damage-resistant coating and FIG. 3 schematically depicts the process described in the flow diagram. It should be appreciated that FIGS. 2 and 3 are merely illustrative of embodiments of the methods described herein, that not all of the steps shown need be performed, and that steps of embodiments of the methods described herein need not be performed in any particular order.

According to embodiments of the present disclosure, the method may include forming 502 glass containers 900 (specifically glass vials in the example depicted in FIG. 3) from coated glass tube stock 1000, the coated glass tube stock 1000 having an ion-exchangeable glass composition. Forming 502 glass containers 900 may utilize conventional shaping and forming techniques.

The method may further include loading 504 the glass containers 900 into a magazine 604 using a mechanical magazine loader 602. The magazine loader 602 may be a mechanical gripping device, such as a caliper or the like, which is capable of gripping multiple glass containers at one time. Alternatively, the gripping device may utilize a vacuum system to grip the glass containers 900. The magazine loader 602 may be coupled to a robotic arm or other similar device capable of positioning the magazine loader 602 with respect to the glass containers 900 and the magazine 604.

The method may further include transferring 506 the magazine 604 loaded with glass containers 900 to a cassette loading area. Transferring 506 may be performed with a mechanical conveyor, such as a conveyor belt 606, overhead crane or the like. Thereafter, the method may include loading 508 the magazine 604 into a cassette 608. The cassette 608 is constructed to hold a plurality of magazines such that a large number of glass containers can be processed simultaneously. Each magazine 604 is positioned in the cassette 608 utilizing a cassette loader 610. The cassette loader 610 may be a mechanical gripping device, such as a caliper or the like, which is capable of gripping one or more magazines at a time. Alternatively, the gripping device may utilize a vacuum system to grip the magazines 604. The cassette loader 610 may be coupled to a robotic arm or other, similar device capable of positioning the cassette loader 610 with respect to the cassette 608 and the magazine 604.

According to embodiments of the present disclosure, the method may further include loading 510 the cassette 608 containing the magazines 604 and glass containers 900 into an ion exchange tank 614 to facilitate chemically strengthening the glass containers 900. The cassette 608 is transferred to the ion exchange station with a cassette transfer device 612. The cassette transfer device 612 may be a mechanical gripping device, such as a caliper or the like, which is capable of gripping the cassette 608. Alternatively, the gripping device may utilize a vacuum system to grip the cassette 608. The cassette transfer device 612 and attached cassette 608 may be automatically conveyed from the cassette loading area to the ion exchange station with an overhead rail system, such as a gantry crane or the like. The cassette transfer device 612 and attached cassette 608 may be conveyed from the cassette loading area to the ion exchange station with a robotic arm. Alternatively, the cassette transfer device 612 and attached cassette 608 may be conveyed from the cassette loading area to the ion exchange station with a conveyor and, thereafter, transferred from the conveyor to the ion exchange tank 614 with a robotic arm or an overhead crane.

Once the cassette transfer device 612 and attached cassette are at the ion exchange station, the cassette 608 and the glass containers 900 contained therein may be preheated prior to immersing the cassette 608 and the glass containers 900 in the ion exchange tank 614. The cassette 608 may be preheated to a temperature greater than room temperature and less than or equal to the temperature of the molten salt bath in the ion exchange tank. For example, the glass containers may be preheated to a temperature from about 300° C.-500° C.

The ion exchange tank 614 contains a bath of molten salt 616, such as a molten alkali salt, such as KNO₃, NaNO₃ and/or combinations thereof. The bath of molten salt may be 100% molten KNO₃ which is maintained at a temperature greater than or equal to about 350° C. and less than or equal to about 500° C. However, it should be understood that baths of molten alkali salt having various other compositions and/or temperatures may also be used to facilitate ion exchange of the glass containers.

The method may further include ion exchange strengthening 512 the glass containers 900 in the ion exchange tank 614. Specifically, the glass containers are immersed in the molten salt and held there for a period of time sufficient to achieve the desired compressive stress and depth of layer in the glass containers 900. For example, the glass containers 900 may be held in the ion exchange tank 614 for a time period sufficient to achieve a depth of layer of up to about 100 μm with a compressive stress of at least about 300 MPa or even 350 MPa. The holding period may be less than 30 hours or even less than 20 hours. However, it should be understood that the time period with which the glass containers are held in the tank 614 may vary depending on the composition of the glass container, the composition of the bath of molten salt 616, the temperature of the bath of molten salt 616, and the desired depth of layer and the desired compressive stress.

After ion exchange strengthening 512, the cassette 608 and glass containers 900 are removed from the ion exchange tank 614 using the cassette transfer device 612 in conjunction with a robotic arm or overhead crane. During removal from the ion exchange tank 614, the cassette 608 and the glass containers 900 are suspended over the ion exchange tank 614 and the cassette 608 is rotated about a horizontal axis such that any molten salt remaining in the glass containers 900 is emptied back into the ion exchange tank 614. Thereafter, the cassette 608 is rotated back to its initial position and the glass containers are allowed to cool prior to being rinsed.

The cassette 608 and glass containers 900 are then transferred to a rinse station with the cassette transfer device 612. This transfer may be performed with a robotic arm or overhead crane, as described above, or alternatively, with an automatic conveyor such as a conveyor belt or the like. Subsequently the method may include rinsing 514 to remove any excess salt from the surfaces of the glass containers 900 by lowering the cassette 608 and glass containers 900 into a rinse tank 618 containing a water bath 620. The cassette 608 and glass containers 900 may be lowered into the rinse tank 618 with a robotic arm, overhead crane or similar device which couples to the cassette transfer device 612. The cassette 608 and glass containers 900 are then withdrawn from the rinse tank 618, suspended over the rinse tank 618, and the cassette 608 is rotated about a horizontal axis such that any rinse water remaining in the glass containers 900 is emptied back into the rinse tank 618. Optionally, the rinsing operation may be performed multiple times before the cassette 608 and glass containers 900 are moved to the next processing station.

According to embodiments of the present disclosure, the cassette 608 and the glass containers 900 may be dipped in a water bath at least twice. For example, the cassette 608 may be dipped in a first water bath and, subsequently, a second, different water bath to ensure that all residual alkali salts are removed from the surface of the glass article. The water from the first water bath may be sent to waste water treatment or to an evaporator.

The method may further include unloading 516 the magazines 604 from the cassette 608 with the cassette loader 610. Thereafter, the method may include transferring 518 the glass containers 900 to a washing station. The glass containers 900 may be unloaded from the magazine 604 with the magazine loader 602 and transferred to the washing station where the method may further include washing 520 the glass containers with a jet of de-ionized water 624 emitted from a nozzle 622. The jet of de-ionized water 624 may be mixed with compressed air.

Optionally, the method may include inspecting (not depicted in FIG. 2 or FIG. 3) the glass containers 900 for flaws, debris, discoloration and the like. Inspecting the glass containers 900 may include transferring the glass containers to a separate inspection area.

According to embodiments of the present disclosure, the method may further include transferring 521 the glass containers 900 to a coating station with the magazine loader 602 where the damage-resistant coating is applied to the glass containers 900. At the coating station the method may include applying 522 a damage-resistant coating as described herein to the glass containers 900 using ALD. Applying 522 the damage-resistant coating may include exposing the glass containers 900 to a metal precursor and a water precursor. Alternatively, applying 522 the damage-resistant coating may include exposing the glass containers 900 to a metal precursor and an amine precursor. The metal precursor may be, for example, a precursor including aluminum, zirconium, zinc such as diethyl zinc, silicon and titanium. The coating station may include a reactor chamber and applying 522 the damage-resistant coating may include exposing the glass containers 900 to precursors within the reactor chamber. The temperature in the reactor chamber may be between about 100° C. and about 200° C. and the pressure within the reactor chamber may be between about 1 mbar and about 10 mbar. Applying 522 the damage-resistant coating may include applying the coating composition to the entire external surface of the container. Alternatively, applying 522 the damage-resistant coating may include applying the coating composition to a portion of the external surface of the container.

Applying 522 the damage-resistant coating using ALD may include applying the damage-resistant coating in a layer-by-layer process where one layer of the damage-resistant coating is deposited during one ALD-cycle. As used herein, the term “ALD-cycle” refers to a process which includes the following four steps: (i) exposing a glass substrate to a first precursor; (ii) purging the glass substrate with an inert gas (such as nitrogen gas, argon gas, helium gas, etc.); (iii) exposing the substrate to a second precursor; and (iv) purging the substrate with an inert gas (such as nitrogen gas, argon gas, helium gas, etc.). Each layer of the damage-resistant coating may have a thickness of about 0.1 nm to about 5.0 nm. In other words, layer-by-layer deposition as described herein may result in the deposition of about 0.1 nm to about 5.0 nm per ALD-cycle. Utilizing layer-by-layer deposition as described herein may advantageously allow for control and tailoring of the thickness of the damage-resistant coating.

After applying 522 the damage-resistant coating to the glass container 900, the method may include transferring 524 the coated glass containers 100 to a packaging process where the containers are filled and/or to an additional inspection station.

Various properties of the coated glass containers (i.e., coefficient of friction, horizontal compression strength, 4-point bend strength) may be measured when the coated glass containers are in an as-coated condition (i.e., following applying 522 the damage-resistant coating to the glass container 900 without any additional treatments) or following one or more processing treatments, such as those similar or identical to treatments performed on a pharmaceutical filling line, including, without limitation, washing, lyophilization, depyrogenation, autoclaving, or the like.

Depyrogentation is a process wherein pyrogens are removed from a substance. Depyrogenation of glass articles, such as pharmaceutical packages, can be performed by a thermal treatment applied to a sample in which the sample is heated to an elevated temperature for a period of time. For example, depyrogenation may include heating a glass container to a temperature of between about 250° C. and about 380° C. for a time period from about 30 seconds to about 72 hours, including, without limitation, 20 minutes, 30 minutes 40 minutes, 1 hour, 2 hours, 4 hours, 8 hours, 12 hours, 24 hours, 48 hours, and 72 hours. Following the thermal treatment, the glass container is cooled to room temperature. One conventional depyrogenation condition commonly employed in the pharmaceutical industry is thermal treatment at a temperature of about 250° C. for about 30 minutes. However, it is contemplated that the time of thermal treatment may be reduced if higher temperatures are utilized. The coated glass containers, as described herein, may be exposed to elevated temperatures for a period of time. The elevated temperatures and time periods of heating described herein may or may not be sufficient to depyrogenate a glass container. However, it should be understood that some of the temperatures and times of heating described herein are sufficient to dehydrogenate a coated glass container, such as the coated glass containers described herein. For example, as described herein, the coated glass containers may be exposed to temperatures of about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes.

As used herein, lyophilization conditions (i.e., freeze drying) refer to a process in which a sample is filled with a liquid that contains protein and then frozen at −100° C., followed by water sublimation for about 20 hours at about −15° C. under vacuum.

As used herein, autoclave conditions refer to steam purging a sample for about 10 minutes at about 100° C., followed by an about 20 minute dwelling period wherein the sample is exposed to an about 121° C. environment, followed by about 30 minutes of heat treatment at about 121° C.

The coefficient of friction (μ) of the portion of the coated glass container with the damage-resistant coating may be lower than the coefficient of friction of a surface of an uncoated glass container formed from a same glass composition. A coefficient of friction (μ) is a quantitative measurement of the friction between two surfaces and is a function of the mechanical and chemical properties of the first and second surfaces, including surface roughness, as well as environmental conditions such as, but not limited to, temperature and humidity. As used herein, a coefficient of friction measurement for a coated glass container 100 is reported as the coefficient of friction between the outer surface of a first glass container (having an outer diameter of between about 16.00 mm and about 17.00 mm) and the outer surface of second glass container which is identical to the first glass container, wherein the first and second glass containers have the same body and the same coating composition (when applied) and have been exposed to the same environments prior to fabrication, during fabrication, and after fabrication. Unless otherwise denoted herein, the coefficient of friction refers to the maximum coefficient of friction measured with a normal load of 30 N measured on a vial-on-vial testing jig, as described herein.

According to embodiments of the present disclosure, the portion of a coated glass container with the damage-resistant coating may have a coefficient of friction of less than or equal to about 0.55 relative to a like-coated glass container, as determined with the vial-on-vial jig. The portion of a coated glass container with the low-friction coating may have a coefficient of friction of less than or equal to about 0.5, or less than or equal to about 0.4 or even less than or equal to about 0.3. Coated glass containers with coefficients of friction less than or equal to about 0.55 generally exhibit improved resistance to frictive damage and, as a result, have improved mechanical properties. For example, conventional glass containers (without a damage-resistant coating) may have a coefficient of friction of greater than 0.55. According to embodiments of the present disclosure, the portion of the coated glass container with the damage-resistant coating may also have a coefficient of friction of less than or equal to about 0.55 (such as less than or equal to about 0.5, or less than or equal to about 0.4, or even less than or equal to about 0.3) after exposure to lyophilization conditions and/or after exposure to autoclave conditions. The coefficient of friction of the portion of the coated glass container with the damage-resistant coating may not increase by more than about 30% after exposure to lyophilization conditions and/or after exposure to autoclave conditions. For example, the coefficient of friction of the portion of the coated glass container with the damage-resistant coating may not increase by more than about 25%, or about 20%, or about 15%, or even about 10%) after exposure to lyophilization conditions and/or after exposure to autoclave conditions. The coefficient of friction of the portion of the coated glass container with the damage-resistant coating may not increase at all after exposure to lyophilization conditions and/or after exposure to autoclave conditions.

As described herein the coefficient of friction of glass containers (both coated and uncoated) is measured with a vial-on-vial testing jig as described in detail in U.S. Patent Application Publication No. 2013/0224407 assigned to Corning, Incorporated, the contents of which are incorporated herein by reference in its entirety.

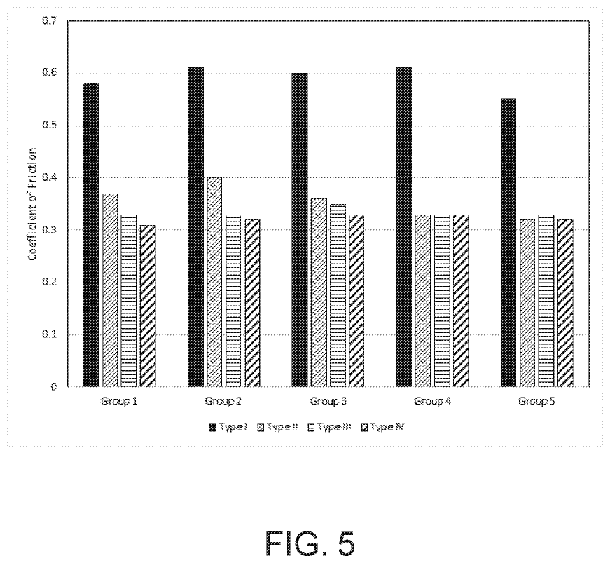

The coefficient of friction was measured for the following four different types of containers: (Type I) as-received, uncoated glass containers; (Type II) as-coated glass container having a zinc oxide damage-resistant; (Type III) coated glass containers having a zinc oxide damage-resistant coating following heat treatment at a temperature of 320° C. for a period of 24 hours; and (Type IV) coated glass containers having a zinc oxide damage-resistant following heat treatment at a temperature of 360° C. for a period of 12 hours. FIG. 5 includes a graph showing the average measured coefficient of friction for five groups (Groups 1-5 in FIG. 5) of the four different types of containers. As shown, all of the as-received, uncoated glass containers have a coefficient of friction above 0.55. In contrast, all of the coated containers have a coefficient of friction below 0.55.

The coated glass containers described herein have a horizontal compression strength. Horizontal compression strength, as described herein, is measured by positioning the coated glass container 100 horizontally between two parallel platens which are oriented in parallel to the long axis of the glass container. A mechanical load is then applied to the coated glass container 100 with the platens in the direction perpendicular to the long axis of the glass container. The load rate for vial compression is 0.5 in/min, meaning that the platens move towards each other at a rate of 0.5 in/min. The horizontal compression strength is measured at 25° C. and 50% relative humidity. A measurement of the horizontal compression strength can be given as a failure probability at a selected normal compression load. As used herein, failure occurs when the glass container ruptures under a horizontal compression in least 50% of samples. Coated glass containers as described herein may have a horizontal compression strength at least 10%, 20%, or even 30% greater than an uncoated vial having the same glass composition.

The horizontal compression strength measurement may also be performed on an abraded glass container. Specifically, operation of the testing jig described above may create damage on the coated glass container outer surface 122, such as a surface scratch or abrasion that weakens the strength of the coated glass container 100. The glass container is then subjected to the horizontal compression procedure described above, wherein the container is placed between two platens with the scratch pointing outward parallel to the platens. The scratch can be characterized by the selected normal pressure applied by a vial-on-vial jig and the scratch length. Unless identified otherwise, scratches for abraded glass containers for the horizontal compression procedure are characterized by a scratch length of 20 mm created by a normal load of 30 N.

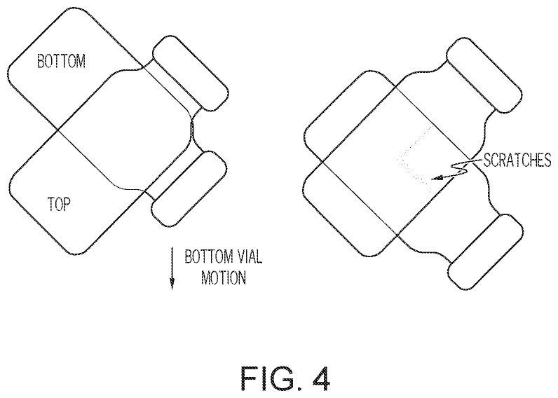

Scratch tests were performed to replicate the interactions of coated glass containers on pharmaceutical filling lines. A container scratching test was used to evaluate effect of static loading. Referring to the schematic of the test setup of FIG. 4, two containers are oriented orthogonally in a fixture with contact between barrels. A Nanovea CB500 mechanical tester applies a controlled, constant load and translates one of the vials linearly. As shown, the translation direction is 45 degrees relative to the barrel direction in order to produce a scratch in virgin surfaces on each container. Moving load forces are applied in order to create controlled scratch along the barrel. The test setup results in the scratches being produced in a virgin surface on both parts as the vials are moved. As-received, uncoated glass containers were tested under the scratch test with an applied load ranging between 1 to 30 N representing the range of forces measured on an actual filling line. Coated glass containers were tested under the scratch test with an applied load ranging between 1 to 48 N representing a range of forces which exceed those measured on an actual filling line. Following the scratch tests, the surfaces of the pair of containers was inspected using optical microscopy. Frictive damage was observed on the surface of the uncoated containers as a result of an applied load of about 5 N and severe scratch damage was observed on the surface of the uncoated containers as a result of an applied load of about 30 N. A scratch test was performed on a first as-coated glass container having a zinc oxide damage-resistant coating. No scratch damage was observed on the surface of the first coated container as a result of any applied load between 1 N and 48 N. A scratch test was performed on a second coated glass container having a zinc oxide damage-resistant coating following heat treatment at a temperature of 320° C. for a period of 24 hours. No scratch damage was observed on the surface of the second coated container as a result of the applied loads ranging between 1 to 48 N. A scratch test was performed on a third coated glass container having a zinc oxide damage-resistant coating following heat treatment at a temperature of 360° C. for a period of 12 hours. No scratch damage was observed on the surface of the third coated container as a result of the applied loads ranging between 1 to 48 N.

The coated glass containers can be evaluated for horizontal compression strength following a heat treatment. The heat treatment may be exposure to a temperature of about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes. The horizontal compression strength of the coated glass container as described herein may not reduced by more than about 20%, about 30%, or even about 40% after being exposed to a heat treatment, such as those described above, and then being abraded, as described above.

The coated glass articles described herein may be thermally stable after heating to a temperature of at least 260° C. for a time period of 30 minutes. The phrase “thermally stable,” as used herein, means that the damage-resistant coating applied to the glass article remains substantially intact on the surface of the glass article after exposure to the elevated temperatures such that, after exposure, the mechanical properties of the coated glass article, specifically the coefficient of friction and the horizontal compression strength, are only minimally affected, if at all. This indicates that the low-friction coating remains adhered to the surface of the glass following elevated temperature exposure and continues to protect the glass article from mechanical insults such as abrasions, impacts and the like.

According to embodiments of the present disclosure, a coated glass article is considered to be thermally stable if the coated glass article meets both a coefficient of friction standard and a horizontal compression strength standard after heating to the specified temperature and remaining at that temperature for the specified time. To determine if the coefficient of friction standard is met, the coefficient of friction of a first coated glass article is determined in as-received condition (i.e., prior to any thermal exposure) using the testing jig described above and a 30 N applied load. A second coated glass article (i.e., a glass article having the same glass composition and the same coating composition as the first coated glass article) is thermally exposed under the prescribed conditions and cooled to room temperature. Thereafter, the coefficient of friction of the second glass article is determined using the testing jig to abrade the coated glass article with a 30 N applied load resulting in an abraded (i.e., a “scratch”) having a length of approximately 20 mm. If the coefficient of friction of the second coated glass article is less than 0.55 and the surface of the glass of the second glass article in the abraded area does not have any observable damage, then the coefficient of friction standard is met for purposes of determining the thermal stability of the damage-resistant coating. The term “observable damage,” as used herein means that the surface of the glass in the abraded area of the glass article contains less than six glass checks per 0.5 cm of length of the abraded area when observed with a Nomarski or differential interference contrast (DIC) spectroscopy microscope at a magnification of 100× with LED or halogen light sources. A standard definition of a glass check or glass checking is described in G. D. Quinn, “NIST Recommended Practice Guide: Fractography of Ceramics and Glasses,” NIST special publication 960-17 (2006).

To determine if the horizontal compression strength standard is met, a first coated glass article is abraded in the testing jig described above under a 30 N load to form a 20 mm scratch. The first coated glass article is then subjected to a horizontal compression test, as described herein, and the retained strength of the first coated glass article is determined. A second coated glass article (i.e., a glass article having the same glass composition and the same coating composition as the first coated glass article) is thermally exposed under the prescribed conditions and cooled to room temperature. Thereafter, the second coated glass article is abraded in the testing jig under a 30 N load. The second coated glass article is then subjected to a horizontal compression test, as described herein, and the retained strength of the second coated glass article is determined. If the retained strength of the second coated glass article does not decrease by more than about 20% relative to the first coated glass article then the horizontal compression strength standard is met for purposes of determining the thermal stability of the damage-resistant coating.

According to embodiments of the present disclosure, the coated glass containers are considered to be thermally stable if the coefficient of friction standard and the horizontal compression strength standard are met after exposing the coated glass containers to a temperature of at least about 260° C. for a time period of about 30 minutes (i.e., the coated glass containers are thermally stable at a temperature of at least about 260° C. for a time period of about 30 minutes). The thermal stability may also be assessed at temperatures from about 260° C. up to about 400° C. For example, the coated glass containers may be considered to be thermally stable if the standards are met at a temperature of at least about 270° C., or about 280° C., or about 290° C., or about 300° C., or about 310° C., or about 320° C., or about 330° C., or about 340° C., or about 350° C., or about 360° C., or about 370° C., or about 380° C., or about 390° C., or even about 400° C. for a time period of about 30 minutes.

The coated glass containers disclosed herein may also be thermally stable over a range of temperatures, meaning that the coated glass containers are thermally stable by meeting the coefficient of friction standard and horizontal compression strength standard at each temperature in the range. For example, the coated glass containers may be thermally stable from at least about 260° C. to a temperature of less than or equal to about 400° C., or from at least about 260° C. to about 350° C., or from at least about 280° C. to a temperature of less than or equal to about 350° C., or from at least about 290° C. to about 340° C., or from about 300° C. to about 380° C., or even from about 320° C. to about 360° C.

After the coated glass container 100 is abraded by an identical glass container with a 30 N normal force, the coefficient of friction of the abraded area of the coated glass container 100 may not increase by more than about 20% following another abrasion by an identical glass container with a 30 N normal force at the same spot, or may not increase at all. For example, after the coated glass container 100 is abraded by an identical glass container with a 30 N normal force, the coefficient of friction of the abraded area of the coated glass container 100 may not increase by more than about 15% or even 10% following another abrasion by an identical glass container with a 30 N normal force at the same spot, or does not increase at all. However, it is not necessary that all embodiments of the coated glass container 100 display such properties.

The transparency and color of the coated container may be assessed by measuring the light transmission of the container within a range of wavelengths between 400-700 nm using a spectrophotometer. The measurements are performed such that a light beam is directed normal to the container wall such that the beam passes through the low-friction coating twice, first when entering the container and then when exiting it. Light transmission through coated glass containers as described herein may be greater than or equal to about 55% of a light transmission through an uncoated glass container for wavelengths from about 400 nm to about 700 nm. As described herein, a light transmission can be measured before a thermal treatment or after a thermal treatment, such as the heat treatments described herein. For example, for each wavelength of from about 400 nm to about 700 nm, the light transmission may be greater than or equal to about 55% of a light transmission through an uncoated glass container. The light transmission through the coated glass container may be greater than or equal to about 55%, about 60%, about 65%, about 70%, about 75%, about 80%, or even about 90% of a light transmission through an uncoated glass container for wavelengths from about 400 nm to about 700 nm.

As described herein, a light transmission can be measured before an environmental treatment, such as a thermal treatment described herein, or after an environmental treatment. For example, following a heat treatment of about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C., for a period of time of 30 minutes, or after exposure to lyophilization conditions, or after exposure to autoclave conditions, the light transmission through the coated glass container may be greater than or equal to about 55%, about 60%, about 65%, about 70%, about 75%, about 80%, or even about 90% of a light transmission through an uncoated glass container for wavelengths from about 400 nm to about 700 nm

The coated glass container 100 as described herein may be perceived as colorless and transparent to the naked human eye when viewed at any angle, or the damage-resistant coating 120 may have a perceptible tint, such as a gold hue when the damage-resistant coating 120 includes a zinc oxide.

The coated glass container 100 as described herein may have a damage-resistant coating 120 that is capable of receiving an adhesive label. That is, the coated glass container 100 may receive an adhesive label on the coated surface such that the adhesive label is securely attached. However, the ability of attachment of an adhesive label is not a requirement for all embodiments of the coated glass containers 100 described herein.

While the present disclosure includes a limited number of embodiments, those skilled in the art, having benefit of this disclosure, will appreciate that other embodiments can be devised which do not depart from the scope of the present disclosure.

What is claimed is:

1. A coated glass article comprising:
a glass body having a first surface and a second surface opposite the first surface, wherein the first surface is an exterior surface of the glass body; and
a damage-resistant coating formed by atomic layer deposition, the damage-resistant coating being disposed on at least a portion of the first surface of the glass body.

2. The coated glass article of claim 1, wherein the damage-resistant coating comprises a material selected from the group consisting of an oxide material and a nitride material.

3. The coated glass article of claim 1, wherein the damage-resistant coating comprises an oxide material selected from the group consisting of oxides of aluminum, zirconium, zinc, silicon and titanium.

4. The coated glass article of claim 1, wherein the damage-resistant coating comprises a nitride material selected from the group consisting of nitrides of aluminum, boron and silicon.

5. The coated glass article of claim 1, wherein the damage-resistant coating comprises a thickness of less than or equal to about 1 μm.

6. The coated glass article of claim 1, wherein the damage-resistant coating comprises a thickness of between about 25 nm and about 1 μm.

7. The coated glass article of claim 1, wherein the damage-resistant coating comprises a plurality of layers, each of the plurality of layers having a thickness of between about 0.1 nm and about 5 nm.

8. The coated glass article of claim 1, comprising a coefficient of friction of less than or equal to 0.55.

9. The coated glass article of claim 1, wherein the glass body comprises borosilicate glass.

10. The coated glass article of claim 1, wherein the first surface is only partially coated with the coating.

11. The coated glass article of claim 1, wherein the first surface comprises side walls of a container, a bottom of the container, or both.

12. The coated glass article of claim 1, wherein the coated glass article is a coated glass container.

13. The coated glass article of claim 1, wherein the coated glass article is a coated glass vial.

14. The coated glass article of claim 1, wherein the coated glass article is chemical strengthened glass.

15. The coated glass article of claim 1, wherein the coated glass article is chemical strengthened glass having a compressive stress of greater than or equal to about 300 MPa.

16. The coated glass article of claim 1, wherein the coated glass article is chemical strengthened glass having a depth of layer of greater than or equal to about 20 μm.

17. A method for forming a coated glass container having a damage-resistant coating, the method comprising:
applying a damage-resistant coating to a glass container by atomic layer deposition, wherein applying the damage-resistant coating comprises exposing the glass container to a metal precursor and at least one of a water precursor and an amine precursor.

18. The method of claim 17, wherein the metal precursor comprises a precursor selected from the group consisting of an aluminum precursor, a zirconium precursor, a zinc precursor, a silicon precursor and a titanium precursor.

19. The method of claim 17, wherein exposing the glass container to a metal precursor and at least one of a water precursor and an amine precursor comprises exposing the glass container in a reactor chamber.

20. The method of claim 17, wherein applying a damage-resistant coating to a glass container comprises applying the damage-resistant coating to substantially all of the external surface of the glass container.

21. The method of claim 17, wherein applying a damage-resistant coating to a glass container comprises applying the damage-resistant coating to a portion of the external surface of the glass container.

22. The method of claim 17, wherein exposing the glass container to a metal precursor and at least one of a water precursor and an amine precursor comprises exposing the glass container at a temperature of between about 100° C. and about 200° C.

23. The method of claim 17, wherein exposing the glass container to a metal precursor and at least one of a water precursor and an amine precursor comprises exposing the glass container at a pressure of between about 1 mbar and about 10 mbar.

24. The method of claim 17, wherein applying a damage-resistant coating comprises applying a plurality of layers of the damage-resistant coating in a layer-by-layer process, wherein each layer of the plurality of layers is deposited during an ALD-cycle.

25. The method of claim 24, wherein each layer of the plurality of layers of the damage-resistant coating comprises a thickness of between about 0.1 nm and about 5.0 nm.

26. The method of claim 1, wherein the coated glass container are selected from the group consisting of vials, ampoules, cartridges and syringe bodies.
